(19) United States
(12) Patent Application Publication
(10) Pub. No.: US 2005/0155786 A1
(43) Pub. Date: Jul. 21, 2005

(54) Apparatus bushing with silicone-rubber housing

(76) Inventors: Robert A. Krol, North Charleston, SC (US); Christopher J. Wetherill, Woodruff, SC (US)

Correspondence Address: Luke Anderson;McGuireWoods, LLP, The Proscenium, 1170 Peachtree Street, N.E., Atlanta, GA, 30309-7649, US

(21) Appl. No.: 10/680,677

(22) Filed: Oct. 7, 2003

Related U.S. Application Data
(63) Continuation-in-part of application No. 10/062,679, filed on Jan. 30, 2002, now abandoned.
(60) Provisional application No. 60/266,080, filed on Feb. 2, 2001.

(51) Int. Cl. H02G 15/00

(52) U.S. Cl. 174/137 A

(57) ABSTRACT

The present invention is an oil-free apparatus bushing with a silicone-rubber housing bonded directly to a capacitance-graded core, and a method for making an apparatus bushing with a silicone-rubber housing bonded directly to a capacitance-graded core. The silicone-rubber housing has numerous performance, environmental, and safety advantages over the traditional oil-filled porcelain bushings that are well known in the art. The advantages include eliminating moisture ingress, eliminating the need for oil, which can cause environmental contamination, and eliminating porcelain which in the event of a violent failure can cause flying damaging debris.

### PRIORITY

This application is a continuation-in-part of co-pending application Ser. No. 10/062,679 filed on Jan. 30, 2002, which claims priority from the related provisional patent application Ser. No. 60/266,080, filed on Feb. 2, 2001.

### BACKGROUND OF THE INVENTION

1. Field of the Invention

The present invention generally relates to apparatus bushings, and more particularly, to a silicone-rubber housing bonded directly to the core of an apparatus bushing, which eliminates the need for a dielectric filler inside the bushing.

2. Background Description

Apparatus bushings are commonly used for conducting and insulating electricity and transitioning power lines into transformers and other electrical hardware. There are many types of electrical apparatus bushing designs. For example, dry type (air core) bushings, oil-impregnated paper core bushings, and resin-impregnated paper core bushings. Dry type (air core) bushings generally have porcelain housings, also commonly referred to as porcelain bushings, that are brittle and susceptible to breakage. Porcelain bushings are also heavy and difficult to handle. Dirt and salt can also coat the porcelain bushing housing, forming a coating capable of conducting electricity, that increases the possibility of flashover and reduces the performance characteristics of the bushing.

Oil-impregnated paper core and resin-impregnated core capacitor bushings are well known in the industry too, and require a dielectric filler oil around the core. The oil inside the bushing is prone to leaking, which reduces the bushings performance and contaminates the environment. Oil Leakage is most frequently attributed to cracks in the gaskets used to seal the oil in around the core. When oil seeps out, moisture can seep in to the oil reservoir and accumulate. Moisture in the oil around the core further reduces the dielectric strength of the core and remaining oil. Such a reduction in dielectric strength can cause electric arcing, catastrophic explosive failure, and the resulting spray of porcelain shrapnel that can damage near by equipment and injure people.

Bushings insulate and conduct electricity and are well known in the prior art. U.S. Pat. No. 4,505,033 discloses a method for making a two piece insulating housing for a bushing. The first piece is constructed by extruding unvulcanized elastomer sheath on to a capacitance-graded bushing core. The second piece, the insulating shed, is not placed in direct contact with the core, rather they are slid over the sheathed core and positioned along the sheathed core at its desired location. The sheds are then warmed to shrink to fit the sheathed core's diameter. The bushings made by this method have been known to fail when the sheds slip or move unexpectedly. These bushings have also been known to fail due to separation between the sheath and the core, thus permitting voids to form next to the core in which electrical partial discharge can occur.

The present invention is directed to overcoming one or more of the problems as set forth above.

### SUMMARY OF THE INVENTION

A first aspect of the present invention is the apparatus bushing is oil-free which exhibits superior performance characteristics and has added flexibility of use compared to the traditional oil-filled bushings commonly known in the art.

Another aspect of the present invention is the very strong chemical and mechanical bond between the silicone-rubber housing and the core that eliminates damaging electrical partial discharge activity while the bushing is energized in service.

Another aspect of the present invention is the silicone-rubber housing on the apparatus bushing eliminates moisture ingress, which is commonly known in the art, by bonding the silicone-rubber housing directly to the conducting and insulating core, thus eliminating the need for gaskets that can crack and unseat to allow moisture ingress into the bushing.

Still another aspect of the present invention is the apparatus bushing can be mounted in any orientation since it is oil-free and does not require an oil reservoir that needs to be filled when the bushing is installed and eliminates the accidental overfilling of the bushing with oil that results in environmental contamination. Thus, the apparatus bushing provides greater flexibility of use and application.

Still another aspect of the present invention is when a violent failure of the apparatus bushing occurs, the silicone-rubber housing will not produce any harmful flying debris of dangerous porcelain the way the traditional oil-filled bushing with a porcelain housings would.

Still another aspect of the present invention is the silicone-rubber housing's smooth, hydrophobic surface offers superior performance in contaminated environments compared to the traditional porcelain surfaces commonly known in the art because the hydrophobic properties of the silicone-rubber housing permit isolation and insulation of surface contamination such as sea salt, industrial pollution, agricultural dust, chemical deposits, and the like.

In a preferred embodiment of the invention the apparatus bushing has an oil-free, paper-foil capacitor core for conducting and insulating electricity comprising conductive layers of aluminum foil and high dielectric paper wound together around the stud to form the bushing's capacitance-graded core that produces uniformly valued capacitors in series. A flange is securely fastened to the capacitor core with a potting adhesive. The silicone-rubber housing is molded directly onto the capacitance-graded core by placing the capacitor core and flange assembly in a mold and introducing liquid silicone-rubber into the mold.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows a preferred embodiment of an apparatus bushing;

FIG. 2 shows a cross section of an apparatus bushing;

FIGS. 3 through 5 show performance charts.

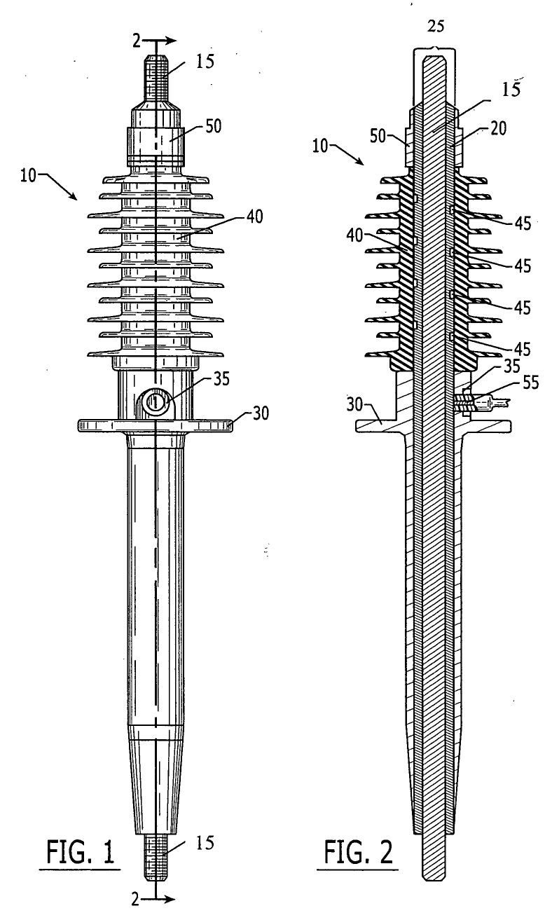

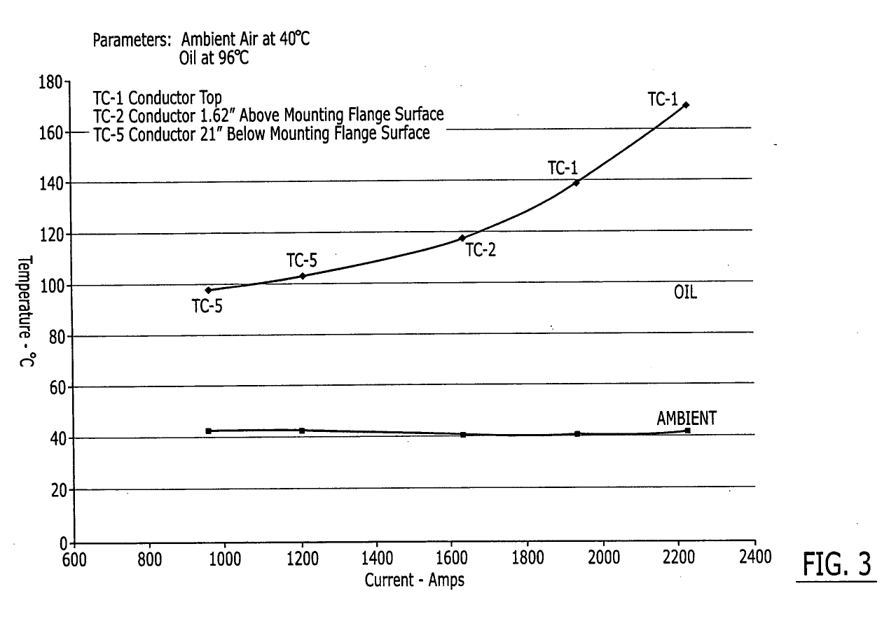

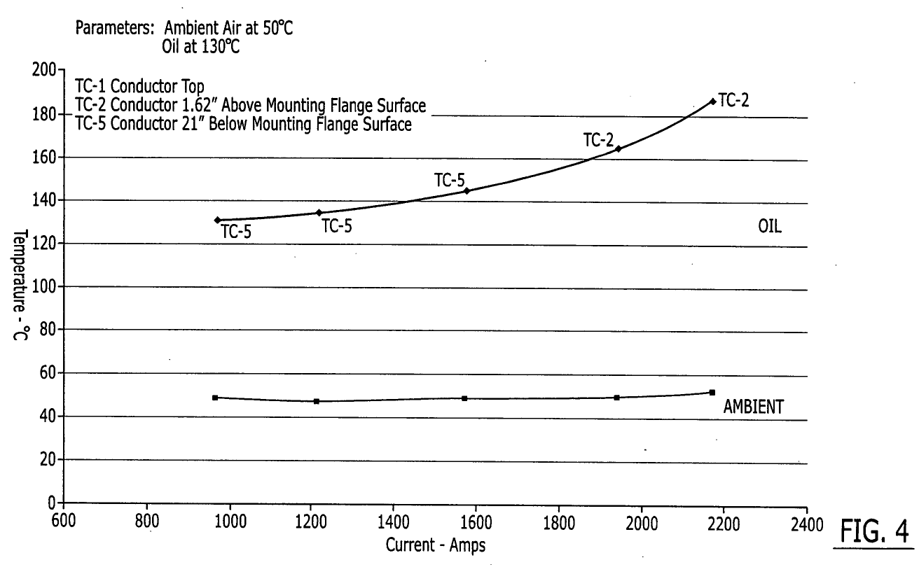

### DETAILED DESCRIPTION OF A PREFERRED EMBODIMENT OF THE INVENTION

The present invention is directed to an oil-free apparatus bushing with a silicone-rubber housing, more specifically with a silicone-rubber housing bonded directly to the apparatus bushing's capacitance-graded core that conducts electrical current and insulates electrical voltage.

Referring now to FIG. 1, the preferred embodiment of the apparatus bushing 10 has a stud 15 of either an aluminum or copper for conducting electrical current that extends the entire lateral distance of the apparatus bushing 10. Multiple layers of a crepe paper and foil 20 are wound around the stud 15 to provide an insulating medium for the electrical voltage. The multiple layers of crepe paper and foil 20 are fully impregnated with an epoxy resin and together the crepe paper, foil matrix 20 and the stud 15 form a capacitance-graded core 25. A flange 30, that is adapted to receive the core 25, is securely fastened to the lower half of the apparatus bushing 10 with an adhesive commonly known in the art as potting adhesive. The flange 30, typically made of aluminum, provides mechanical strength and protection to the core 25, while also providing a mounting surface for securing the apparatus bushing 10 to an electric transformer or other device. A power factor test tap 35 may also be included on the flange 30 for testing the power factor of the apparatus bushing 10. The power factor test tap 35 is connected to an electrical lead wire that is also connected to the core 25.

The silicone-rubber housing 40 is bonded directly to the conductive and insulating core 25. In the preferred embodiment, the silicone-rubber housing 40 is a single unitary constructed piece that is bonded directly to the core 25, continuously from the top of the housing 40 to the bottom of the housing 40. In preparation for the bonding of the silicone-rubber housing 40, the core 25 is turned on a lathe to provide a smooth finished surface and to cut a series of recesses 45 about an inch wide and a half-inch deep into the core 25. These recesses 45 form a channel which, when filed with silicone-rubber, provide a physical-mechanical lock that helps secure the silicone-rubber housing 40 to the core 25. The preferred embodiment has a silicone-rubber housing 40 cast in one piece from a free-flowing, fast-curing, liquid silicone-rubber. When the silicone-rubber vulcanizes it forms a rigid, yet pliable silicone-rubber housing 40 with superior electrical properties that exceed industry standards. One source of liquid silicone-rubber is Wacker Chemie, GmbH's Powersil® 600.

Depending on the apparatus bushing's 10 desired application, a draw lead terminal 50 may be attached to the top of the apparatus bushing 10 by a positioning pin and retaining nut. Then, a threaded screw-on top terminal may be attached to the top of the apparatus bushing 10.

### DETAILED METHOD OF MANUFACTURING THE PREFERRED EMBODIMENT OF THE INVENTION

The method for making the preferred embodiment begins by securely attaching a plurality of crepe paper, and foil layers 20 to a stud 15 by winding each layer around the stud 15. The foil layers 20 are made of conductive media selected from the group consisting of: a metal, a conductive ink, a conductive element of paper, or other conductive media commonly known in the art. The most common conductive media metals are aluminum and copper. Conductive inks are generally comprised of a blend of powdered silver and carbon suspended in a polymer resin. Fumed silica can also be added to the polymer resin as a thixotropic thickening agent to help stabilize the silver carbon suspension. A conductive element of paper consists of either powdered carbon being impregnated into a paper substrate to form a carbon band or a carbon ribbon being pressed or formed into a paper substrate. The stud 15 is typically either aluminum or copper. The process, up to this point, has formed an unprocessed core. Then, in preparation for impregnating, the unprocessed core, the stud 15 and crape paper, foil matrix 20 are dried to remove all moisture, which includes any hygroscopic moisture associated with the crepe paper, foil matrix 20. The unprocessed core is then placed into a mold. Then these unprocessed cores in molds are placed inside a pressure vessel. A vacuum is pulled on the pressure vessel and epoxy resin is injected into each mold. The vacuum assists the diffusion of epoxy resin into the unprocessed core and more specifically impregnating the crepe paper, foil matrix 20 with epoxy resin. The core 25 is now processed. After removal of the processed core from the mold, the core 25 is then machined on a lathe to its finished dimensions by removing a section of the epoxy resin coating in preparation of the core's 25 surface to receive the silicone-rubber housing 40. During the machining step, either a single or a series of recesses 45 may be cut into the epoxy resin portion of the core 25. The recesses 45 will later be filled with liquid silicone-rubber, which when the silicone-rubber cures, will provide a physical restraining structure to keep the silicone-rubber housing 40 from slipping on the epoxy resin surface of the core 25. The epoxy resin surface of the core 25 is then sealed with a clear coat track resistant polyurethane. Then a primer is applied to the core's surface to increase the silicone-rubber's ability to bond mechanically and chemically with the core 25.

The core 25 is then inserted inside a flange 30 designed to securely hold the core 25. The bottom end of the core 25 extends beyond the bottom edge of the flange 30 by several inches. The core 25 is then placed in a metal mold. The mold is connected to a reservoir of liquid silicone-rubber. A gas, preferably a noble gas, such as nitrogen, can be introduced in the reservoir as back pressure to aid the flow of the liquid silicone into the mold. The silicone-rubber bonds directly to the capacitance-graded core 25. In the preferred embodiment, the silicone-rubber bonds directly to the capacitance-graded core 25, continuously in one piece from the top of the housing 40 to the bottom of the housing 40. The silicone-rubber cures and vulcanizes in the mold, forming a single piece housing.

The final step for completing the apparatus bushing is to seal the top of the bushing, just above the silicone-rubber housing 40, with water proof silicone, an O-ring, and a threaded screw on cap 50.

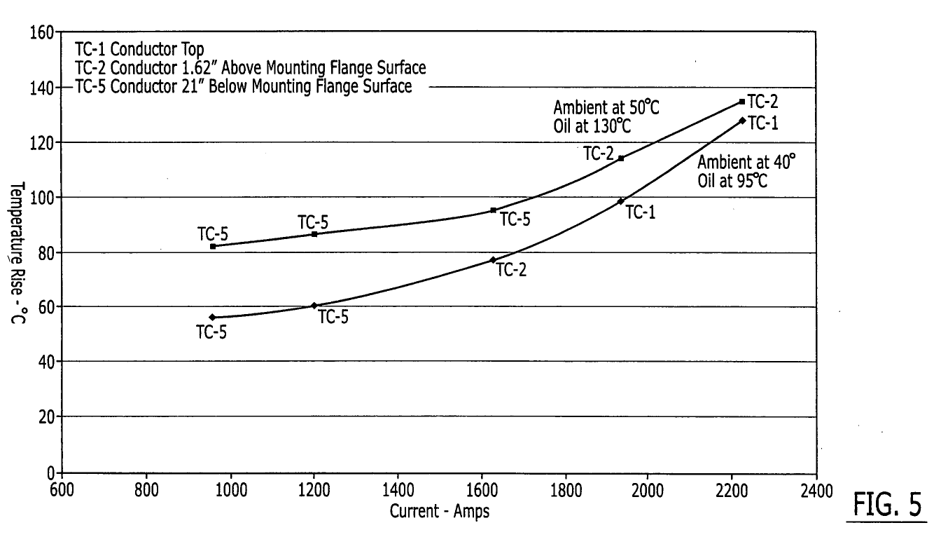

FIGS. 5 though 7 chart the performance of the apparatus bushing as its hot spot is determined at the top of the conductor, 1.62 inches above the mounting flange surface, and 21 inches below the mounting flange surface.

While the invention has been described in terms of preferred embodiments, those skilled in the art will recognize that the invention can be practiced with modification within the spirit and scope of the appended claims.

1. A bushing for conducting and insulating electricity comprising:
a core;
a flange securely fastened to said core; and
a housing permanently fastened directly to said core.

2. A bushing according to claim 1 wherein:
said housing is one unitary piece, having a top end and bottom end, and is permanently fastened directly to said core, continuously from the top of said housing to the bottom of said housing.

3. A bushing according to claim 2 wherein:
said housing is comprised of silicone-rubber.

4. A bushing according to claim 1 wherein:
said core consists of a stud with resin-impregnated paper-foil matrix wound around said stud for increased capacitance-grading.

5. A bushing according to claim 4 wherein:
said resin-impregnated paper-foil matrix further comprising a plurality of crepe paper and foil matrix layers wound around said stud; and
an epoxy resin encapsulating said plurality of crepe paper and foil matrix layers.

6. A bushing according to claim 5 wherein:
said foil matrix is selected from a group consisting of a metal, a conductive ink, or a conductive element paper.

7. A bushing for conducting and insulating electricity according to claim 1 wherein:
said flange is further comprised of a power factor test tap for testing the power factor of said apparatus bushing; and
said power factor test tap is connected to said core by an electrical wire.

8. A bushing for conducting and insulating electricity according to claim 1 wherein:
said core has at least one recess for physically-mechanically attaching said housing to said core.

9. A bushing for conducting and insulating electricity according to claim 1 wherein:
said flange is further comprised of a power factor test tap for testing the power factor of said bushing; and
said power factor test tap is connected to an end of an electrical wire, and the other end of said electrical wire is connected to said core.

10. An apparatus bushing for conducting and insulating electricity comprising:
a core
a flange adapted for receiving said core, where said flange is permanently bonded to said core; and
a housing directly bonded to said core.

11. An apparatus bushing for conducting and insulating electricity according to claim 10 wherein:
said housing is of unitary construction, having a top end and a bottom end, and is permanently molded to said core.

12. An apparatus bushing for conducting and insulating electricity according to claim 11 wherein:
said housing is a rubber housing.

13. An apparatus bushing for conducting and insulating electricity according to claim 11 wherein:
said housing is comprised of silicone-rubber.

14. An apparatus bushing for conducting and insulating electricity according to claim 10 wherein:
said core is comprised of a stud around which a plurality of resin-impregnated crepe paper and foil matrix layers are wound.

15. An apparatus bushing for conducting and insulating electricity according to claim 10 wherein:
said foil matrix is selected from a group consisting of a metal, a conductive ink, or a conductive element paper.

16. An apparatus bushing for conducting and insulating electricity according to claim 10 wherein:
said core has at least one recess for physically-mechanically attaching said housing to said cord.

17. An apparatus bushing for conducting and insulating electricity according to claim 10 wherein:
said flange is further comprised of a power factor test tap for testing the power factor of said apparatus bushing; and
said power factor test tap is connected to an end of an electrical wire, and the other end of said electrical wire is connected to said core.

18. A bushing comprising:
a core for conducting and insulating electricity comprising a stud and a plurality of crepe paper and foil matrix layers wound around said stud and impregnated with epoxy resign;
a flange securely fastened to said core; and
a silicone-rubber housing of unitary construction, having a top and a bottom end;
said silicon-rubber housing being permanently bonded directly to said core continuously from the top of said housing to the bottom of said housing.

19. A bushing produced according to the process of:
Forming a core by securing a plurality of crepe paper and foil matrix layers to a stud;
Drying of said core to remove moisture;
Impregnating said core with an epoxy resin;
Machining of said core to finished dimensions;
Sealing the surface of said core with a polyrethane;
Bonding a flange to said core with an adhesive; and
Applying to the surface of said core a bonding primer; and
Molding a one piece housing directly to the surface of said core.
